(19) United States
(12) Patent Application Publication
(10) Pub. No.: US 2026/0009450 A1
(43) Pub. Date: Jan. 8, 2026

(54) BUFFER PAD AND LEVER

(71) Applicant: TSUBAKIMOTO CHAIN CO., Osaka (JP)

(72) Inventors: Yuta Watanabe, Osaka (JP); Shoichiro Shimizu, Osaka (JP)

(73) Assignee: TSUBAKIMOTO CHAIN CO., Osaka (JP)

(21) Appl. No.: 19/252,751

(22) Filed: Jun. 27, 2025

(30) Foreign Application Priority Data
Jul. 5, 2024 (JP) 2024-109173

(51) Int. Cl. F16H 7/08; F16H 7/18

(52) U.S. Cl. CPC F16H 7/0829; F16H 7/18; F16H 2007/185

(57) ABSTRACT

To provide a buffer pad and a lever that can suppress noise and vibration that occur when a plunger cannot follow the lever swing. A buffer pad 2 is provided at a location on a base member 11 of a lever 1 where a plunger of a chain tensioner abuts against the base member, the buffer pad 2 having a thermoplastic molded body made of a thermoplastic elastomer in at least a part thereof.

### BACKGROUND OF THE INVENTION

### 1. Field of the Invention

The present invention relates to a buffer pad and a lever.

### 2. Description of the Related Art

In a conventional timing chain system, a tensioner is provided close to a swing lever because it is necessary to apply an appropriate tension to a timing chain in order to transmit the power of the timing chain. The tensioner includes a cylinder with the other axial end open and a plunger inserted into the cylinder to be capable of axially sliding therein. The plunger is in contact with the base of the swing lever, and the tensioner swings the swing lever to adjust the tension of the chain.

In order to reduce noise and vibration and to prevent wear on the plunger and base, it is known to provide the swing lever with a polyamide buffer pad on the abutment surface of the base with the plunger, or to form the base of a polyamide so as to obtain a configuration in which no buffer pad is provided and the base itself functions as a pad (for example, U.S. Pat. No. 9,394,978).

### SUMMARY OF THE INVENTION

However, when there is a shortage of oil in the tensioner or when the chain behavior changes, the plunger may not be able to follow the lever swing, and at such times the plunger may collide with the buffer pad, causing noise and vibration.

The present invention was made in consideration of the above problems and aims to provide a buffer pad and a lever that can suppress the noise and vibration that occur when the plunger cannot follow the lever swing.

The buffer pad of the present invention is provided at a location on a base member of a lever where a plunger of a chain tensioner abuts against the base member, the buffer pad having a thermoplastic molded body made of a thermoplastic elastomer in at least a part thereof. Because the pad provided at the location where the plunger of the chain tensioner abuts has a thermoplastic molded body made of a thermoplastic elastomer in at least a part thereof, rubber elasticity can be imparted to the buffer pad, thereby making it possible to suppress noise and vibration that occur when the plunger cannot follow the lever swing.

It is preferable that the thermoplastic molded body have a thickness of 1 mm or more in a load input direction from the chain tensioner. By having a thermoplastic molded body of such a thickness, rubber elasticity can be preferably imparted to the buffer pad.

In a preferred embodiment of the present invention, the buffer pad further has a portion made of a thermoplastic resin.

The buffer pad preferably has an attachment portion that is attached to a position at the lever facing the tensioner, and an abutment portion that is provided at the attachment portion and abuts against the plunger, wherein the attachment portion is the thermoplastic molded body, or the abutment portion is the thermoplastic molded body. As a result of the attachment portion being the thermoplastic molded body, or the abutment portion being the thermoplastic molded body, rubber elasticity can be easily imparted to the buffer pad.

It is preferable that the attachment portion include a pedestal portion connected to the abutment portion and claw portions provided on the pedestal portion on the opposite side to the abutment portion, that the pedestal portion have a through hole formed therein, and that a protrusion of the abutment portion be inserted into the through hole to fix the abutment portion. By inserting the protrusion of the abutment portion into the through hole to fix the abutment portion, the abutment portion can be easily fixed to the attachment portion.

It is preferable that the buffer pad have an attachment portion that is attached and fixed to a position of the lever facing the tensioner, and an abutment portion that is provided at the attachment portion and abuts against the plunger, wherein the attachment portion and the abutment portion are formed integrally, and the thermoplastic molded body made of the thermoplastic elastomer is disposed inside the abutment portion.

The thermoplastic elastomer is preferably a polyester-based elastomer. Polyester-based elastomers have high heat resistance and oil resistance and can be used even in engine environments.

The lever of the present invention is swung by a chain tensioner, wherein any of the above-mentioned buffer pads is fixed to a location on the lever where a plunger of the chain tensioner abuts against the lever. By providing the buffer pad described above at the location where the plunger of the chain tensioner abuts, rubber elasticity can be imparted to the location where the plunger abuts, thereby making it possible to suppress noise and vibration that occur when the plunger cannot follow the lever swing.

According to the present invention, it is possible to suppress noise and vibration that occur when the plunger cannot follow the lever swing.

### BRIEF DESCRIPTION OF THE DRAWINGS

FIG. 1 shows a lever according to Embodiment 1 of the present invention;

FIG. 2 is a perspective view showing a buffer pad according to Embodiment 1 of the present invention;

FIG. 3 is a perspective view showing the buffer pad according to Embodiment 1 of the present invention;

FIG. 4 is an exploded perspective view showing the lever and the buffer pad according to Embodiment 1 of the present invention;

FIG. 5 is a perspective view showing a buffer pad according to Embodiment 2 of the present invention;

FIG. 6 is an exploded perspective view showing the buffer pad according to Embodiment 2 of the present invention;

FIG. 7 illustrates the noise deadening effect exhibited when the buffer pad of the present invention is used;

FIG. 8 illustrates the vibration suppression effect exhibited when the buffer pad of the present invention is used; and

FIG. 9 is a perspective view of a buffer pad according to a modified example of the present invention.

### DESCRIPTION OF THE PREFERRED EMBODIMENTS

Below, embodiments of the present invention will be described in detail with reference to the attached drawings. However, the embodiments are merely exemplary, and the present invention is not limited thereto.

### Embodiment 1

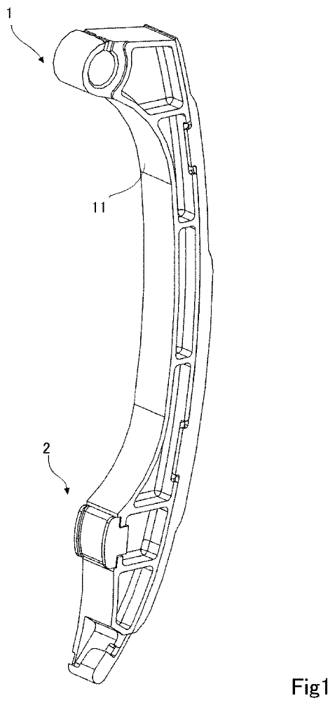

FIG. 1 shows a swing lever 1 of the present embodiment. The swing lever 1 is provided in a timing chain system. The timing chain system includes a driving sprocket and a driven sprocket (not shown) and a timing chain (not shown) that is wound therebetween. The timing chain is assembled with the swing lever 1, and a chain tensioner (not shown, hereinafter also referred to as a tensioner) is provided close to the swing lever 1. The tensioner includes a plunger that is slidable in the axial direction of the cylinder. The swing lever 1 is swung and pressed toward the timing chain by the plunger of the tensioner, so that the tension of the timing chain is properly maintained, and the swing lever 1 swings against the biasing force of the plunger in response to tension fluctuations and vibrations of the timing chain, thereby absorbing these tension fluctuations and vibrations. A buffer pad 2 is provided on a base member 11 of the swing lever 1 at a position facing the plunger.

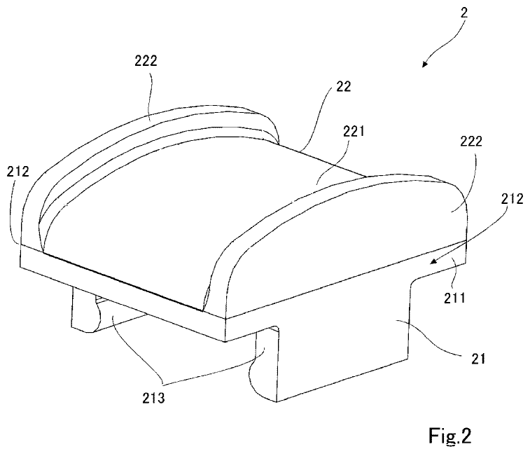

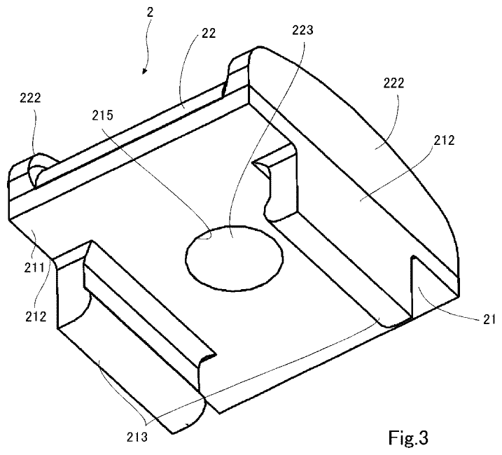

The buffer pad 2 will be described with reference to FIGS. 2 and 3. In the present embodiment, the buffer pad 2 has an attachment portion 21 attached to the swing lever 1 at a position facing the plunger P, and an abutment portion 22 fixed to the attachment portion 21. The abutment portion 22 abuts against the plunger.

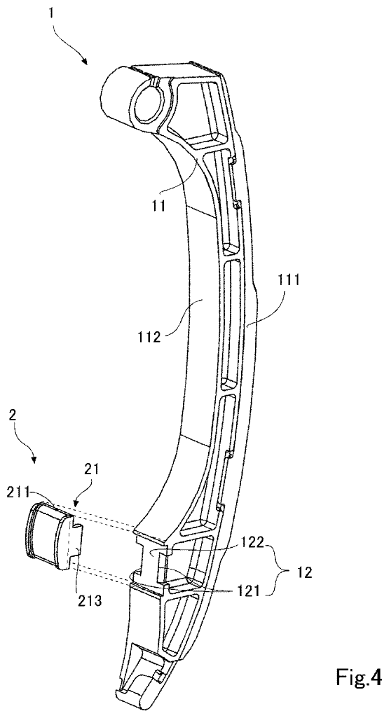

The attachment portion 21 includes a pedestal portion 211 that serves as the base of the buffer pad 2, and a pair of claw portions 213 provided at both ends 212 of the pedestal portion 211 on the opposite side to the abutment portion 22. As shown in FIG. 4, the base member 11 of the swing lever 1 includes a guide surface 111 along which the timing chain slides, and an opposing surface 112 that constitutes the surface on the opposite side to the guide surface 111 and faces the tensioner, and a fitting portion 12 is provided at the position of the opposing surface 112 where the buffer pad 2 is to be attached, i.e., the position facing the plunger. The fitting portion 12 is formed to fit with the attachment portion 21 of the buffer pad 2, and specifically, consists of recesses 121 provided at both ends of the opposing surface 112 in the width direction, and a step portion 122 formed to be recessed with respect to the opposing surface 112. The recesses 121 and step portion 122 are formed correspondingly to the pedestal portion 211 and the claw portions 213, respectively, and by placing the pedestal portion 211 on the step portion 122 and engaging the claw portions 213 with the recesses 121, the attachment portion 21 is fitted into the fitting portion 12. In this way, the buffer pad 2 is attached and fixed to the swing lever 1. The pedestal portion 211 and claw portions 213 are formed integrally.

The abutment portion 22 includes an abutment surface 221 that is on the opposite side to the pedestal portion 211 and abuts against the plunger, and wall portions 222 that cover the side surfaces of the abutment portion 22 and stand upright from both ends 212 of the pedestal portion 211. The wall portions 222 and the claw portions 213 are provided facing upward and downward, respectively, from both ends 212 of the pedestal portion 211. The abutment surface 221 and the wall portions 222 are formed integrally. The abutment surface 221 is a gently curved surface and is sandwiched between the wall portions 222 so that the plunger does not come off the abutment portion 22.

In the present embodiment, the abutment portion 22 is made of a thermoplastic elastomer, and the attachment portion 21 is made of a thermoplastic resin. As a result, by using a thermoplastic molded body made of a thermoplastic elastomer for at least a part of the buffer pad 2, it is possible to give the buffer pad 2 itself rubber elasticity. Although thermoplastic resins and thermoplastic elastomers share a thermoplastic property, thermoplastic elastomers have rubber elasticity, which thermoplastic resins do not have, and exhibit less creep than thermoplastic resins. One example of such an elastomer is one having a rubber hardness of D75 or less, in the case of durometer type D, as the surface hardness thereof. The conventional buffer pads provided on the swing lever were made of polyamides, and therefore did not have rubber elasticity. As a result, noise and vibrations at the time of collision with the plunger could not be sufficiently suppressed. In the present embodiment, the buffer pad 2 is provided with a thermoplastic molded body, and rubber elasticity can be given to the buffer pad 2 without changing the shape (mass) of the swing lever 1 or the shape of the tensioner in order to suppress the noise and vibrations. As a result, the buffer pad 2 can absorb the input load from the plunger and reduce noise. In addition, the vibration from the plunger to the swing lever 1 and/or the vibration from the timing chain to the tensioner through the swing lever 1 can be reduced by being transmitted through the thermoplastic molded body of the buffer pad 2.

In order to give the buffer pad 2 rubber elasticity, rubber can be used for the buffer pad 2. However, since rubber cannot be recycled as a material and has a low degree of freedom in shape selection due to poor moldability, it is preferable to use a thermoplastic elastomer as described above. Another advantage of the buffer pad 2 using a thermoplastic elastomer is that even if the shape of the buffer pad 2 is deformed when the buffer pad 2 is pressed by the plunger, since the buffer pad 2 has rubber elasticity, the original shape is easily restored. Such a buffer pad 2 can be produced by extrusion molding or injection molding. In this case, since the molding temperature of thermoplastic elastomers is lower than that of polyamides, the power consumption and carbon dioxide emissions are also low.

Examples of thermoplastic elastomers include olefin-based elastomers, styrene-based elastomers, urethane-based elastomers, amide-based elastomers, ester-based elastomers, and fluoroelastomers. These thermoplastic elastomers have a compression set of less than 80% and can be preferably used. Among these, ester-based elastomers are preferred, and polyester-based elastomers, which have high heat resistance and oil resistance and can be used even in engine environments, are particularly preferred. Examples of polyester-based elastomers include copolymers of PBT (C₁₂H₁₂O₄) n as a hard segment and a polyether (COC) as a soft segment, and copolymers of a polyester as a hard segment and polystyrene (C₈H₈)ₙ as a soft segment.

The thickness of the abutment portion 22 (in the present embodiment, from the location on the abutment surface 221 with the smallest thickness to the surface of the pedestal portion 211) is configured to be 1 mm or more in the load input direction from the tensioner (arrow A in the figure). Because the thickness of the abutment portion 22 made of a thermoplastic elastomer is 1 mm or more at all times in the load input direction from the tensioner, the buffer pad 2 can be preferably given rubber elasticity, the input load from the plunger can be absorbed and noise can be preferably reduced.

As shown in FIG. 3, a through hole 215 is provided in the center of the pedestal portion 211, and this through hole 215 is also filled with a thermoplastic elastomer. That is, the abutment portion 22 has a protrusion 223 on the opposite side to the abutment surface 221, and the protrusion 223 fits into the through hole 215. In this way, the abutment portion 22 is fixed to the attachment portion 21. By configuring the abutment portion 22 of a thermoplastic elastomer as in the present embodiment, such complex molding is facilitated, and the abutment portion 22 can be easily fixed to the attachment portion 21.

Furthermore, the thermoplastic resin that constitutes the attachment portion 21 is preferably one or more of amide-based resins such as polyamides and polyphthalamides, polybutylene terephthalate, polyphenylene sulfides, polycarbonates, and a polyether ether ketones. Amide-based resins are particularly preferred, and polyamides are most preferred; in the present embodiment, polyamide 66 resin is used.

### Embodiment 2

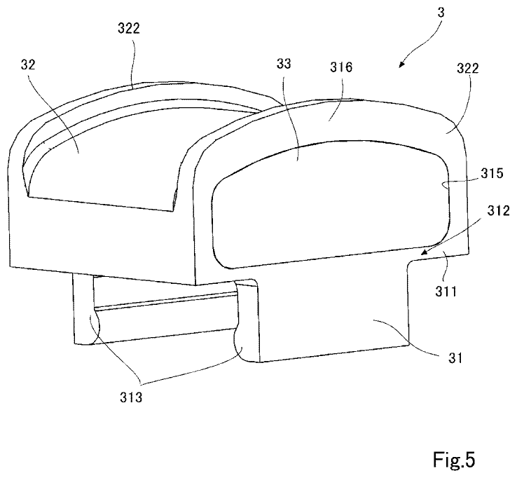

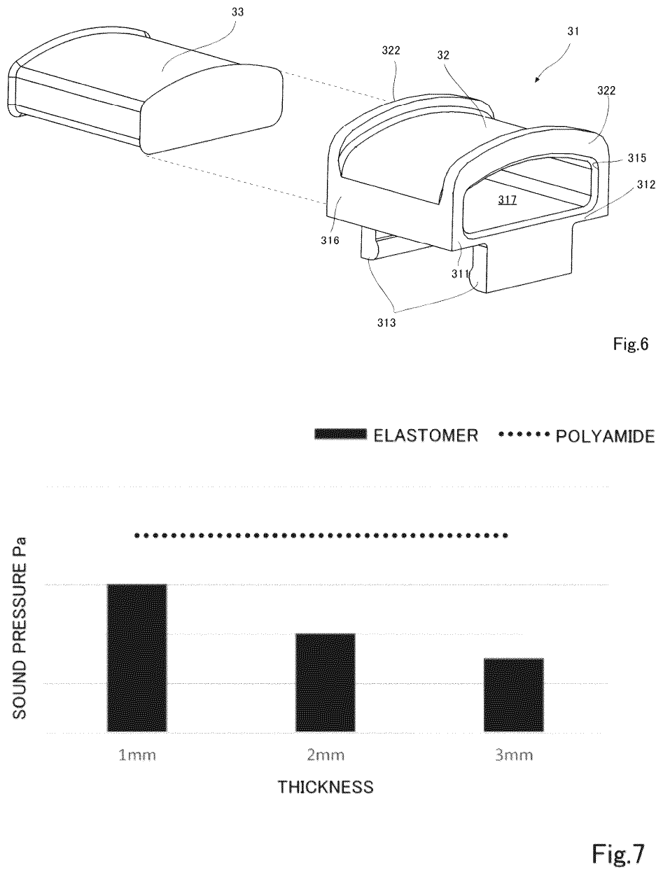

A buffer pad 3 according to the present embodiment that is shown in FIGS. 5 and 6 has a different shape from the buffer pad 2 in Embodiment 1. In Embodiment 2, the description of the same features as in Embodiment 1 will be omitted.

In the present embodiment, the buffer pad 3 has an attachment portion 31 and an abutment portion 32 provided at the attachment portion 31. As shown in FIG. 5, the attachment portion 31 has a pedestal portion 311 and a pair of claw portions 313 provided at both ends 312 of the pedestal portion 311. Wall portions 322 stand upright from both ends 312 of the pedestal portion 311 in the opposite direction to the claw portions 313. In the present embodiment, the wall portions 322 standing upright from the pedestal portion 311 are formed integrally with the attachment portion 31 (pedestal portion 311). An opening 315 is formed in the center of the wall portion 322. In addition, the upper surface formed to be integral with the wall portions 322 and extending between the two wall portions 322 constitutes the abutment portion 32. That is, the abutment portion 32 and the pedestal portion 311 constitute a cylindrical portion 316, and the openings 315 of the wall portions 322 communicate with an internal space 317 of the cylindrical portion 316. The opening 315 is configured to be slightly wider than the internal space 317. The internal space 317 and the openings 315 are filled with a thermoplastic molded body 33 made of the same thermoplastic elastomer as in the Embodiment 1. Since the opening 315 is wider than the internal space 317, the cross-sectional area of the portion of the thermoplastic molded body 33 filled in the opening 315 is wider than the cross-sectional area of the portion of the thermoplastic molded body filled in the internal space 317. As a result, the thermoplastic molded body 33 is sufficiently fixed to the attachment portion 31.

In this case as well, although the abutment portion 32 and the attachment portion 31 are made of a thermoplastic resin, since the buffer pad 3 has the thermoplastic molded body 33 and thus has rubber elasticity as a whole, the input load from the plunger can be absorbed, noise can be reduced, etc. Furthermore, since the thermoplastic molded body 33 has a thickness of 1 mm or more, it is possible to more preferably absorb the input load from the plunger, reduce noise, etc.

### EXAMPLE

First, a polyester-based elastomer (a polyester-based elastomer that is a copolymer of PBT (C₁₂H₁₂O₄)ₙ as a hard segment and a polyether (COC) as a soft segment) was made into a sheet (plate) and the thickness was varied from 1 mm to 3 mm. The sheet made of this polyester-based elastomer was placed on an iron plate, an iron ball was dropped from a specific height onto the sheet, and a sound pressure was measured at this time with a microphone to perform a sound deadening evaluation. As a comparative example, a polyamide was also made into a plate of the same shape, and a sound deadening evaluation was performed in the same way. The results are shown in FIG. 7.

As shown in FIG. 7, with the polyamide, the sound pressure was constant at all times even when the thickness was changed, and in all cases the sound pressure was higher than that with the polyester-based elastomer. Meanwhile, with the polyester-based elastomer, the sound pressure decreased as the plate thickness was increased, a higher effect than in the case of polyamide could be obtained from 1 mm, and the sound deadening characteristics were excellent.

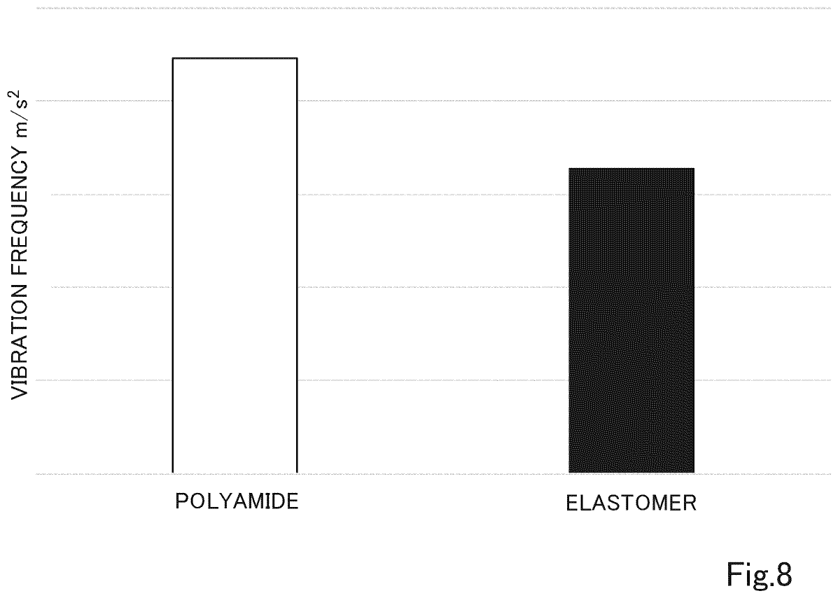

Next, a vibration evaluation was performed using the buffer pad 2 in which the abutment portion 22 was made of a polyester-based elastomer (a polyester-based elastomer that is a copolymer of PBT (C₁₂H₁₂O₄)ₙ as a hard segment and a polyether (COC) as a soft segment). The measurement conditions for the vibration evaluation were that the buffer pad 2 was attached to the base member 11 of the lever 1, and that the tensioner plunger was abutted against the buffer pad 2. In this state the vibration evaluation was performed by running the timing chain. As a comparative example, the vibration evaluation was performed under the same conditions except that a buffer pad in which both the attachment portion and the abutment portion were made of polyamide was used. The results are shown in FIG. 8.

As shown in FIG. 8, it was found that the vibration value of the buffer pad 2 was lower than that of the buffer pad in which both the attachment portion and the abutment portion were made of polyamide, and the use of the buffer pad 2 of the present embodiment could reduce vibration.

### Modified Examples

The present invention is not limited to the above-mentioned embodiments. For example, the buffer pads 2 and 3 may be formed by attaching a sheet-shaped thermoplastic molded body to a predetermined position of the swing lever 1, instead of using the shape of the buffer pads 2 and 3 consisting of the attachment portions 21 and 31 and the abutment portions 22 and 32 as in the above-mentioned embodiments. In this case, the same effect can be obtained by using a thermoplastic molded body including a thermoplastic elastomer in at least a part thereof, and it is more preferable that the thickness of the thermoplastic molded body be 1 mm or more in the load input direction from the tensioner. In such a case, the thermoplastic molded body may be made of a thermoplastic elastomer. In other words, it is sufficient that the buffer pad be fixed to a predetermined position of the swing lever 1 and abut against the plunger to buffer the impact caused by the collision.

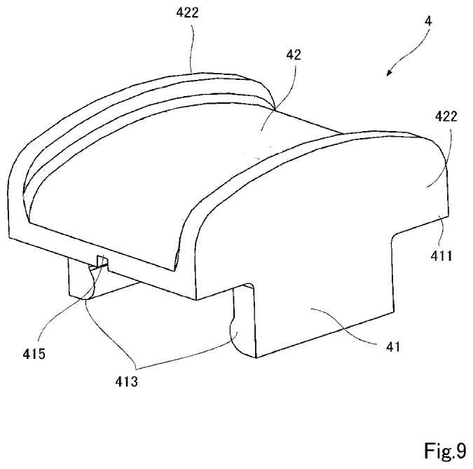

As yet another modified example, for example, in a buffer pad 4 shown in FIG. 9, a pedestal portion 411 of an attachment portion 41 and wall portions 422 are provided integrally, and only a portion constituting an abutment surface 421 is made of a thermoplastic elastomer. In addition, a groove portion 415 is further provided on the surface of the pedestal portion 411 of the attachment portion 41 where claw portions 413 are provided. With such a configuration as well, the buffer pad 4 as a whole has rubber elasticity, so that the input load from the plunger can be absorbed, noise can be reduced, etc.

In Embodiment 1, a configuration was explained in which the abutment portion 22 was made of a thermoplastic elastomer, and the attachment portion 21 was made of a thermoplastic resin, but this configuration is not limiting, and the abutment portion 22 may be made of a thermoplastic resin, and the attachment portion 21 may be made of a thermoplastic elastomer. With such configuration as well, since the thermoplastic elastomer is provided in a portion of the buffer pad 2, the buffer pad 2 as a whole has rubber elasticity, so that the input load from the plunger can be absorbed, noise can be reduced, etc. In this case, the through hole 215 may not be provided in the pedestal portion 211, and the abutment portion 22 may be bonded to the pedestal portion 211 by two-color molding or may be fixed with a separate material such as an adhesive. The wall portions 222, 322, and 422 may also be integrally formed with the attachment portions 21, 31, and 41. In addition, only the abutment surface 221 in Embodiment 1 may be formed from a thermoplastic elastomer. In this case, where the thickness of the abutment surface 221 is 1 mm or more, rubber elasticity can be preferably imparted. Furthermore, in Embodiment 1, a configuration was explained in which the abutment portion 22 was made of a thermoplastic elastomer, and the attachment portion 21 was made of a thermoplastic resin. However, as long as at least the abutment portion 22 is made of a thermoplastic elastomer, the attachment portion 21 is not limited to a thermoplastic resin and may be made of another material.

The shape of the lever is not limited to that shown in FIGS. 1 and 4, and the buffer pad of the present invention can be applied even to a lever having a shorter length.

What is claimed is:

1. A buffer pad provided at a location on a lever, which is swung by a chain tensioner, where a plunger of the chain tensioner abuts against the lever,
the buffer pad having a thermoplastic molded body made of a thermoplastic elastomer in at least a part thereof.

2. The buffer pad according to claim 1, wherein the thermoplastic molded body has a thickness of 1 mm or more in a load input direction from the chain tensioner.

3. The buffer pad according to claim 1, wherein the buffer pad further has a portion made of a thermoplastic resin.

4. The buffer pad according to claim 1, the buffer pad comprising an attachment portion that is attached and fixed to a position at the lever facing the chain tensioner, and an abutment portion that is provided at the attachment portion and abuts against the plunger, wherein
the abutment portion is the thermoplastic molded body.

5. The buffer pad according to claim 1, the buffer pad comprising an attachment portion that is attached to a position at the lever facing the chain tensioner, and an abutment portion that is provided at the attachment portion and abuts against the plunger, wherein
the attachment portion is the thermoplastic molded body.

6. The buffer pad according to claim 4, wherein
the attachment portion includes a pedestal portion connected to the abutment portion and claw portions provided on the pedestal portion on the opposite side to the abutment portion,
the pedestal portion has a through hole formed therein, and a protrusion of the abutment portion is inserted into the through hole to fix the abutment portion.

7. The buffer pad according to claim 1, the buffer pad comprising an attachment portion that is attached and fixed to a position at the lever facing the chain tensioner, and an abutment portion that is provided at the attachment portion and abuts against the plunger, wherein
the attachment portion and the abutment portion are formed integrally, and the thermoplastic molded body made of the thermoplastic elastomer is disposed in an internal space of the abutment portion.

8. The buffer pad according to claim 1, wherein the thermoplastic elastomer is a polyester-based elastomer.

9. A lever that is swung by a chain tensioner, wherein the buffer pad according to claim 1 is fixed to a location on the lever where a plunger of the chain tensioner abuts against the lever.
